(19) United States
(12) Patent Application Publication
(10) Pub. No.: US 2006/0270450 A1
(43) Pub. Date: Nov. 30, 2006

(54) Voice activated distance measuring device

(76) Inventors: Reginald G. Garratt, Chicago, IL (US); Gail Garratt, Chicago, IL (US); Sean R. Garratt, Schaumburg, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/417,740

(22) Filed: May 4, 2006

Related U.S. Application Data
(60) Provisional application No. 60/679,525, filed on May 10, 2005.
(60) Provisional application No. 60/756,259, filed on Jan. 4, 2006.

(51) Int. Cl. H04M 1/00

(52) U.S. Cl. 455/556.1

(57) ABSTRACT

A voice activated device for annunciating a message indicative of a distance of the device spaced from another location is disclosed. The device comprises a voice sensor for receiving a voice command requesting annunciation of a message indicative of the distance of the device spaced from the other location, converting circuitry coupled to the voice sensor for converting the received voice command to a corresponding electrical command, determining circuitry responsive to the electrical command for determining the distance of the device from the other location, and a speaker coupled to the determining circuitry for annunciating the message indicative of the determined distance of the device from the other location. The device may be used for informing a golfer of the golfer's distance from the pin.

### CROSS-REFERENCE TO RELATED APPLICATION

This application claims priority of U.S. provisional patent applications Ser. No. 60/679,525, filed May 10, 2005, and 60/756,259, filed Jan. 4, 2006.

### FEDERALLY SPONSORED RESEARCH OR DEVELOPMENT

Not Applicable.

### TECHNICAL FIELD

This invention generally relates to a voice activated distance measuring device, such as for providing distance and other information to a golfer.

### BACKGROUND OF THE INVENTION

Range finding devices, such as the SkyCaddie range finder sold by Skyhawke Technologies, LLC (see www.skygolfgps.com), are known and provide information to golfers, such as the distance to a golf pin. However such devices require manual requests for information and provide only visual display of the requested information, which can be cumbersome to the golfers.

The present invention is provided to address this and other issues.

### BRIEF DESCRIPTION OF THE DRAWINGS

FIG. 1 is a plan view of a printed circuit board in accordance with the invention;

FIG. 2 is a perspective view of the printed circuit board assembly of FIG. 1, mounted in the brim of a hat; and

FIG. 3 is a view of the printed circuit board and brim of FIG. 2, illustrating a recess in the brim to receive the printed circuit board assembly.

### DETAILED DESCRIPTION OF THE INVENTION

While this invention is susceptible of embodiment in many different forms, there will be described herein in detail, specific embodiments thereof with the understanding that the present disclosure is to be considered as an exemplification of the principles of the invention and is not intended to limit the invention to the specific embodiments illustrated.

The present invention is a device that measure distances on a golf course and provides other relevant information. The device is useful for other applications, as well. The device uses voice recognition technology and GPS technology to provide a user, such as a golfer, with required data on the golf course and its parameters in a verbal electronically spoken form. The electronics and software for this device may be incorporated into an article of clothing, or other portable device, such as an article of headgear, including a golf hat or visor. The device may alternatively use distance measuring technology such as infra red, optics, Doppler acoustics and the like.

The device uses commercially available GPS data, such as supplied by Sports Mapping, Inc., or similar company, providing golf course mapping data to convert GPS mapped longitude and latitude coordinates to measure distance and other factors.

The device may use any GPS system available to measure the longitude and latitude coordinates to compute the distance and other golf course parameters.

The device incorporates voice recognition technology to accept voice commands from the user which are sensed by a voice sensor, such as a bone conductance vibration sensor or a microphone, which drives the voice recognition software. The device responds to voice commands such as “distance,” “pin-placement,” or any other such word or words.

Commands may also be in the form of an electrical signal from a switch or any electrical pulse generated by touch or remote control.

The device incorporates voice synthesis technology to provide an audible output by electronically produced spoken words, to provide distance and other information to the user via a loudspeaker or headphone, following a verbal command from the user. The output acoustics can be adjusted for volume level and frequency filtered for any particular user requirement or application. The device may also provide in a verbal form other information such as the green size, pin placement and other information on the golf course parameters.

The GPS and voice recognition electronics, for the GPS distance measurement and the voice recognition circuits and software, including the voice sensor, speaker and power source, may be incorporated into any design of headgear, such as a hat or visor, such as golf headgear, or any other article of clothing for golf or other sport.

As an additional feature the device may also accept verbal or any other data input and memorize and compute this, when prompted by voice command or an electrical pulse generated by touch or remote control, to predict golf course user golf strategy, club selection, rules and other golf player needs. For example the user may verbally enter information, either directly or by a verbal prompt, such as the club selected for the shot. The GPS technology determines the actual distance traveled by the ball and its accuracy. Information regarding weather conditions, such as wind speed and wind direction, may also be provided. Over time the device may build a library of information regarding the golfer's personal shot results, such as how far does a ball typically travel, and how accurately, when hit with each club. The device may collate and memorize this information and function as an expert system to progressively learn the golfer's successes and failures to generate a strategic recommendation which may also be based on an algorithm which is developed for this system. In summary this information can be used to provide the golfer with recommendations for future golf shots based on the golfer's past performance.

The bone conductance vibration sensor receives audio from the user directly from vibrations conducted through the skull of the user by direct mechanical contact of the sensor to the user's forehead. Such technology is superior to conventional microphones in that the user's voice is picked up clearly while substantially all external noise, such as but not limited to side chatter or wind noise, is rejected. There will be an increase in voice recognition accuracy achieved by the use of the bone conductance vibration sensor.

The unique design of this device, in one possible form as a hat or similar headgear, facilitates direct contact of the bone conductance vibration sensor with the user's forehead, providing the headgear design a unique advantage.

This device may also be used to provide pre recorded golf instructions to assist the golfer in making a specified golf shot, when prompted to do so by a voice recognition command.

The device may be used for such applications as hiking, surveyors and hunters and other applications. The device may also be used for scuba divers using an underwater design which may use any latitude and longitude measurement technology.

The device may be expanded to include its use in any portable application.

The device may be provided with a communications method, such as but not limited to a serial, USB or wireless connection to a separate personal computer or similar technology provided by the user of this device. The device may be able to upload and download data to the separate computer to facilitate various detailed functions, if such functions are beyond the scope of the device by itself such as, but not limited to, graphical display of the users score and plot of all ball trajectories viewed against an image of the subject golf course, display of clubs used, comparative display of any other player or players using the system, expert system advice based on data accrued during one or more recorded games, printing of results and scorecards. The connection may also facilitate uploading of new course databases to the device and management thereof, training of voice recognition commands and management of those commands.

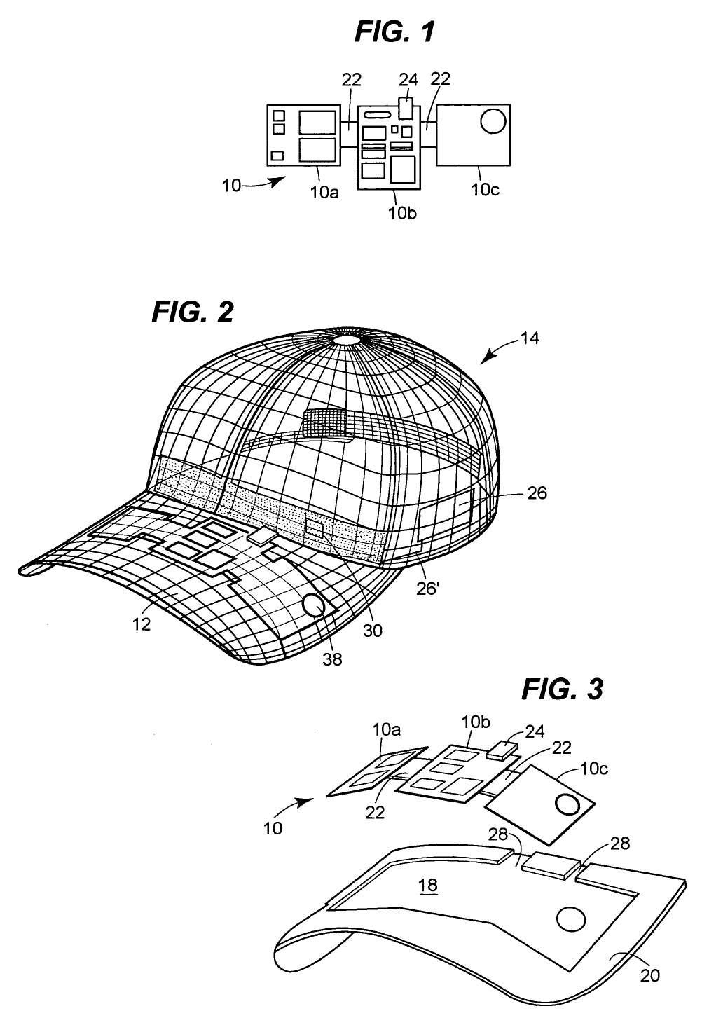

A main printed circuit board (PCB) assembly 10 to reside in a brim 12 of a hat 14 is illustrated in FIGS. 1, 2 and 3. The circuitry for the device is substantially mounted on the PCB assembly 10. The PCB assembly 10 is seated in and supported by, a molded space 18 in a plastic brim stiffener 20. The PCB assembly 10 is composed of three rigid printed circuit boards 10a, 10b, 10c, connected by flexible flat cable 22, so as to permit the PCB assembly 10 to follow the curvature of the brim 12.

The center PCB 10b of the PCB assembly 10 has a connector extension 24, 1 cm long, designed to extend through hat fabric and be accessible from the inside hat.

Referring to FIG. 3, a rectangular battery 26 is sewn into a compartment on a side of the hat 14, positioned and padded for comfortable wear. Battery wiring 26′ runs through the hat and connects to the PCB assembly 10 using a channel detent 28 in the stiffener 20 (See FIG. 3). An internal headband area holds a transducer 30, such as a bone conductance vibration sensor, supported by acoustic dampening material. The bone conductance vibration sensor will contact a wearer's forehead, with support elastic sewn in to assure the device maintains @20 g contact pressure, while maintaining comfort. Alternatively a conventional acoustical microphone could be utilized.

Referring to FIG. 3, the plastic brim insert stiffener 20 has the molded space 18 for the PCB assembly 10. Two channels are cut out at the rear to allow for PCB connector and wiring channel. The brim 12 further includes a circular opening 38 for a down facing speaker.

The top of the PCB assembly 10 is protected by layer of electrostatic protective padding material, and is finished in a fabric of similar weave and color to hat body.

Bluetooth, a known and published radio frequency short range data/audio transfer technology, may be used in the device for five primary purposes, data transfers, as an audio server, as an audio client, short range audio communications and as a remote GPS.

Externally sourced data transfers to the device's internal nonvolatile storage memory may be via a wired connection to the device's internal nonvolatile storage memory. Wireless installation of golf course data or program updates via Bluetooth or similar technology will allow such conveniences as allowing a golfer to upload golf course GPS coordinate data while in the pro shop or retail outlet without needing a wired connection or even removing the hat device from his/her head. This will facilitate and encourage users to purchase golf course files.

The device may include Bluetooth technology, a conventional communication/data/audio transfer technology, for five primary purposes, data transfers, as an audio server, as an audio client, short range audio communications and as a remote GPS.

As a Bluetooth audio server, it will be possible for the user to use a separate Bluetooth headset of the type used often in cell phones to access the voice recognition input and audio output of the device, without using the hat device's own built in speaker/voice sensor. This would enable the user to use the device even if the hat were not worn, or indeed if the device were not in a hat at all, and was implemented as any other form of wearable computer not requiring a built in speaker/voice sensor.

As a Bluetooth audio client, the hat device's speaker/voice sensor could be used for an auxiliary headset for another Bluetooth audio server such as a cell phone, in the same manner a Bluetooth ear clip headset is currently used.

As a short range audio communications client, it would be possible for two users of the device to maintain wireless audio communications providing they were in range typical of Bluetooth devices, usually 100 m maximum.

As a remote GPS, it would be possible for a user to use the GPS contained in the hat device with another program which required a GPS by transmitting the coordinate data over the Bluetooth using known Bluetooth protocols for GPS data transmission.

The device further permits a user to record geographic coordinates of a golf course, including its hazards and fairway boundaries, by use of a portable computing device equipped with a global positioning (GPS) device. Such recording can be done by, but not limited to, voice commands, keyboard, mouse or touch screen input. The device is running a program in the form of compiled computer code that continually receives updated latitude and longitude coordinates from the GPS, and on receiving input from the user, records those coordinates in permanent storage, such as but not limited to non-volatile memory or magnetic recording of a file on disk.

The user in the process of recording the course travels physically to course locations such as but not limited to tee off points, fairway boundaries, sand trap boundaries, water boundaries and green boundaries. Upon physically reaching the exact geographic point desired, the user indicates the hole number of the course and the type of course location using an input method previously described. The geographic coordinates (latitude, longitude, altitude) are then appended to non-volatile storage as previously described.

The golf course recording process will be designed in such a way as to allow the average person who is not necessarily an expert in computer or GPS technologies an easy method to record any golf course that s/he may wish to record, and allow for that course recording to be electronically transmitted to others for the purposes of sharing recorded courses and building up a shared collection of recorded courses. Upon completion of the recording of course features, the complete file containing multiple instance recordings of course name, hole number, hole feature and geographic location can be used to facilitate the calculation of geographic distances between the golfers current GPS position and those features, such as but not limited to the distance from the golfer to the center of the green. Other course feature recordings may be used also in the process of giving the golfer advice, by relating his/her current geographic position to those features. The recorded course data may also be used for other purposes, such as but not limited to information for greens keepers to assist in course maintenance or the production of maps or computer models.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A voice activated device for annunciating a message indicative of a distance of the device spaced from another location, the device comprising:
a voice sensor for receiving a voice command requesting annunciation of a message indicative of the distance of the device spaced from the other location;
converting circuitry couple to the voice sensor for converting the received voice command to a corresponding electrical command;
determining circuitry responsive to the electrical command for determining the distance of the device from the other location;
a speaker coupled to the determining circuitry for annunciating the message indicative of the determined distance of the device from the other location.

2. The device of claim 1 wherein the device is disposed in an article of clothing.

3. The device of claim 1 wherein the device is disposed in one of a hat and a visor.

4. The device of claim 3 wherein the device is disposed in a brim of an article of headgear.

5. The device of claim 1 wherein the determining circuitry utilizes GPS technology.

6. The device of claim 1 wherein the determining circuitry utilizes one of infra-red technology, optical measuring technology and Doppler acoustical distance measuring technology.

7. The device of claim 1 wherein the voice sensor comprises a bone conductance vibration sensor.

8. The device of claim 7 wherein the device is disposed in an article of headgear one and the sensor positioned for engagement with the skull of a wearer of the hat.

9. The device of claim 1 wherein the voice sensor comprises a microphone.

10. A voice activated device for informing a golfer of the golfer's location on a golf course relative to another feature on the golf course, the device comprising:
a voice sensor for receiving a voice command requesting annunciation of a message indicative of the distance of the device from the feature;
converting circuitry couple to the microphone for converting the received voice command to a corresponding electrical command;
determining circuitry responsive to the electrical command for determining the distance of the device from the feature;
a speaker coupled to the determining circuitry for annunciating the message indicative of the determined distance of the device from the feature.

11. The device of claim 10 wherein the device is disposed in an article of clothing.

12. The device of claim 10 wherein the converting and determining circuitry are substantially mounted on a printed circuit board.

13. The device of claim 10 wherein the device is disposed in an article of headgear.

14. The device of claim 13 wherein the device is substantially disposed in a brim of one of a hat and a visor.

15. The device of claim 10 wherein the converting and determining circuitry are substantially mounted on a plurality of circuit boards interconnected by flex ribbon cable.

16. The device of claim 15 wherein the device is disposed in an article of headgear.

17. The device of claim 10 wherein the device is disposed in a brim of the article of headgear.

18. The device of claim 10 wherein the determining circuitry utilizes GPS technology.

19. The device of claim 10 wherein the determining circuitry utilizes one of infra-red technology, optical measuring technology and Doppler acoustical distance measuring technology.

20. The device of claim 10 including circuitry for recording graphical coordinates of a golf course.

21. The device of claim 20 wherein the recording of coordinates utilizes one of voice commands, keyboard, mouse and touch screen input.

22. The device of claim 10 wherein the device includes circuitry for recording results of golf shots made by the golfer.

23. The device of claim 19 including circuitry for analyzing recorded results of golf shots made by the golfer.

24. The device of claim 23 including circuitry responsive to the analyzing circuitry for recommending prospective golf shots in response to past, recorded golf shots.

25. The device of claim 10 including circuitry for permitting audible communication with other communication devices.

26. The device of claim 10 including communication circuitry for permitting operation of the device as a wireless headset for a wireless audio server.

27. The device of claim 10 including communication circuitry for communicatively coupling the device to permit downloading golf course information to the device.

28. The device of claim 7 including circuitry to annunciate other course information in response to voice commands.
